(19) United States
(12) Patent Application Publication
(10) Pub. No.: US 2025/0278285 A1
(43) Pub. Date: Sep. 4, 2025

(54) METHOD FOR SUPPORTING INFORMATION COLLECTION FOR SCREEN COMPONENTS

(71) Applicant: NETHRU INC., Seoul (KR)

(72) Inventor: Hunsuk RHIM, Seoul (KR)

(21) Appl. No.: 19/212,600

(22) Filed: May 19, 2025

Related U.S. Application Data
(63) Continuation of application No. PCT/KR2024/008062, filed on Jun. 12, 2024.

(30) Foreign Application Priority Data
Dec. 15, 2023 (KR) 10-2023-0183643

(51) Int. Cl. G06F 9/451; G06F 40/137

(52) U.S. Cl. CPC G06F 9/451; G06F 40/137

(57) ABSTRACT

A method for supporting information collection for screen components performed by a computing device comprising at least one processor is disclosed according to some embodiments of the present disclosure. The method for supporting information collection for the screen components may comprise: accessing a pre-designated library in response to execution of a target application; executing a command for detecting a hierarchy of a parent UI (User Interface) included in the library; determining whether at least one child UI type, which is a lower hierarchy determined according to a type of the parent UI, exists; and generating report information for displaying at least one child object representing the at least one child UI and a parent object representing the parent UI in a pre-designated visualization method, when the at least one child UI exists.

### CROSS-REFERENCE TO RELATED APPLICATION

This application is a US Bypass Continuation Application of International Application No. PCT/KR2024/008062, filed on Jun. 12, 2024, which claims priority to and the benefit of Korean Patent Application No. 10-2023-0183643, filed on Dec. 15, 2023, the disclosure of which is incorporated herein by reference in its entirety.

### BACKGROUND

### Technical Field

The present disclosure relates to a method for supporting information collection for screen components, and more specifically, to a method for supporting information collection for screen components performed by a computing device to collect screen components of a computing device located remotely.

### Background Art

The process of distributing apps for the Android operating system can be summarized as follows.

Application Development: First, the app to be executed on the user terminal must be developed. This process may include user interface design, app logic implementation, and testing.

Application Build: Once app development is complete, the app must be built. Building may refer to the process of compiling source code and packaging it into an APK (Android Package) file.

Signing: The app must be signed. For APK files, adding a signature allows the app to be recognized as a trusted source. Signing may use a debug keystore for development or a release keystore for production.

Google Play Console Registration: To distribute the app on the Google Play Store, it must be registered on the Google Play Console. Through this, app information, pricing, descriptions, screenshots, and version management can be configured.

APK Upload: The APK file is uploaded on the Google Play Console. A release APK file can be uploaded, or various release tracks such as Alpha, Beta, and Production can be set.

Resource and Store Page Configuration: Resources such as app icons, graphic materials, descriptions, and app store pages are configured.

Pricing and Country Configuration: The app's price is set, and the countries where it will be available are specified. Free or paid apps can be selected, and pricing policies can be managed.

Release and Review: The app is released on the Google Play Console and undergoes Google's review process. The review process verifies the app's content and compliance with advertising policies.

Application Distribution: Once the review is complete, the app is distributed on the Google Play Store. Users can search for and download the app from the store.

Application Update Management: When updating the app or releasing a new version, the previous steps are repeated to upload a new APK file and release it.

User Support and Feedback Management: Interaction with users using the app is managed, and feedback and issue reports are handled to contribute to app improvement.

Marketing and Promotion: After successfully distributing the app, marketing and promotional activities are conducted to attract more users and promote the app.

Natively developed Android applications generally need to follow the above distribution process to reflect the application content. Due to the processes of development, build, testing, and distribution, a significant amount of time and resources are consumed, and even when using methods to update the application, the processes of development, build, and testing are still required. Additionally, methods for patching resources remotely cannot change the execution entity, so the changes are limited.

### SUMMARY

### Technical Problem

The present disclosure has been devised in response to the aforementioned background art and aims to provide a method capable of supporting information collection for screen components without requiring rebuilding or redistributing an application.

The technical problems of the present disclosure are not limited to the technical problems mentioned above, and other technical problems not mentioned will be clearly understood by those skilled in the art from the following description.

### Technical Solution

According to an embodiment of the present disclosure for solving the above-described problems, a method for supporting information collection for screen components performed by a computing device including at least one processor is disclosed. The method for supporting information collection for the screen components may comprise: accessing a pre-designated library in response to execution of a target application; executing a command for detecting a hierarchy of a parent UI (User Interface) included in the library; determining whether at least one child UI type, which is a lower hierarchy determined according to a type of the parent UI, exists; and generating report information for displaying at least one child object representing the at least one child UI and a parent object representing the parent UI in a pre-designated visualization method, when the at least one child UI exists.

In addition, the command may comprise a first command defining a type of at least one child UI to be detected according to the type of the parent UI and a second command for detecting the type of the at least one child UI.

In addition, determining whether at least one child UI type, which is a lower hierarchy determined according to the type of the parent UI, exists may comprise repeatedly determining whether the at least one child UI type exists until a lowermost child UI located at a hierarchically lowermost position is determined.

In addition, repeatedly determining whether the at least one child UI type exists until the lowermost child UI located at the hierarchically lowermost position is determined may comprise: determining an activity of the parent UI corresponding to the command; determining at least one DecorView that is a lower hierarchy of the activity; determining at least one child view that is a lower hierarchy of each of the at least one DecorView; and repeatedly determining a lower hierarchy of each of the at least one child view until a lowermost child view of each of the at least one child view is determined.

In addition, the at least one child object may comprise at least one of depth information indicating a depth in the visualization method, an index of the at least one child UI, a class indicating a type of the at least one child UI, a text displayed on a front-end by the at least one child UI, an ID of the at least one child UI, and a tag assigned to the at least one child UI.

In addition, the step of generating the report information for displaying may comprise generating a command for supporting generation of a plurality of graphic objects indicating at least one of a first indicator indicating whether an ID is assigned to the at least one child UI, a second indicator indicating whether the at least one child UI has an operation according to user interaction, a third indicator indicating whether a trigger is assigned to the at least one child UI, and a fourth indicator indicating whether the at least one child UI is a UI displayed to a user, as the report information.

The technical solutions that can be obtained from the present disclosure are not limited to the solutions mentioned above, and other solutions not mentioned may be clearly understood by those skilled in the art to which the present disclosure pertains from the following description.

### Effect of Invention

The present disclosure provides a method capable of supporting information collection for screen components without rebuilding or redistributing an application, according to some embodiments of the present disclosure.

The effects obtainable from the present disclosure are not limited to the effects mentioned above, and other effects not mentioned will be clearly understood by those of ordinary skill in the art to which the present disclosure pertains from the following description.

### BRIEF DESCRIPTION OF THE DRAWINGS

Various aspects are now described with reference to the drawings, wherein like reference numerals are used to collectively refer to like components. In the following embodiments, for the purpose of explanation, numerous specific details are presented to provide a comprehensive understanding of one or more aspects. However, it will be apparent that such aspect(s) can be implemented without these specific details. In other examples, known structures and devices are illustrated in block diagram form to facilitate the description of one or more aspects.

FIG. 1 is a block diagram illustrating an example of a computing device according to some embodiments of the present disclosure.

FIG. 2 is a flowchart illustrating an example of a method for supporting information collection for screen components by a computing device according to some embodiments of the present disclosure.

FIG. 3 is a flowchart illustrating an example of a method for determining a lowermost child UI located at a hierarchically lowermost position by a computing device according to some embodiments of the present disclosure.

FIG. 4 is a diagram illustrating an example of a screen component according to some embodiments of the present disclosure.

FIG. 5 is a diagram for describing at least one child object according to some embodiments of the present disclosure.

FIG. 6 is a flowchart illustrating an example of a method for collecting screen components performed among a user, a computing device, and a server according to some embodiments of the present disclosure.

### DETAILED DESCRIPTION

The present invention may undergo various modifications and have various embodiments, and thus specific embodiments are illustrated in the drawings and described in detail in the detailed description. However, this is not intended to limit the present invention to specific embodiments, and it should be understood to include all modifications, equivalents, and substitutes included in the spirit and scope of the present invention. Similar reference numerals are used for similar components while describing each drawing.

The terms first, second, A, B, etc., may be used to describe various components, but the components should not be limited by these terms. These terms are used only for the purpose of distinguishing one component from another. For example, without departing from the scope of the present invention, a first component may be referred to as a second component, and similarly, a second component may be referred to as a first component. The term “and/or” includes a combination of a plurality of related listed items or any of the plurality of related listed items.

When a component is referred to as being “connected to” or “coupled to” another component, it should be understood that it may be directly connected or coupled to the other component, or there may be intervening components. In contrast, when a component is referred to as being “directly connected to” or “directly coupled to” another component, it should be understood that there are no intervening components.

The terms used in this application are merely for the purpose of describing specific embodiments and are not intended to limit the present invention. Singular expressions include plural expressions unless the context clearly indicates otherwise. In this application, terms such as “comprising” or “having” are intended to specify the presence of features, numbers, steps, operations, components, parts, or combinations thereof described in the specification, and should not be understood to preclude the possibility of the presence or addition of one or more other features, numbers, steps, operations, components, parts, or combinations thereof.

Unless otherwise defined, all terms used herein, including technical and scientific terms, have the same meaning as commonly understood by one of ordinary skill in the art to which this invention belongs. Terms defined in commonly used dictionaries should be interpreted as having meanings consistent with the context of the relevant technology and should not be interpreted in an idealized or overly formal sense unless explicitly defined in this application.

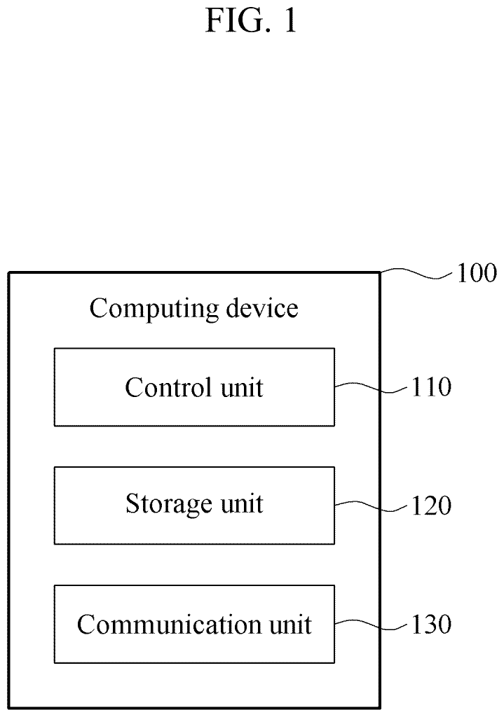

In the present disclosure, a computing device may transmit information about screen components to a server. Specifically, the computing device may access a pre-designated library in response to the execution of a target application. The target application may be an application pre-distributed to the computing device. The target application may be an application in which an SDK (Software Development Kit) is installed in the form of a library. The computing device may execute a command for detecting a hierarchy of screen components included in the library. Here, the command may be a script or the like. The script may be a programming language that can be executed without compiling the source code. Furthermore, the computing device may transmit the collected information about screen components to the server. Accordingly, the user can conveniently collect information about screen components without rebuilding or redistributing the application. Hereinafter, an example of a method for supporting the collection of information about screen components according to the present disclosure will be described with reference to FIGS. 1 to 6.

FIG. 1 is a block diagram illustrating an example of a computing device according to some embodiments of the present disclosure.

Referring to FIG. 1, the computing device 100 may comprise a control unit 110, a storage unit 120, and a communication unit 130. However, the above-described components are not essential for implementing the computing device 100, and the computing device 100 may have more or fewer components than those listed above.

The computing device 100 may include a PC (Personal Computer), notebook, mobile terminal, smartphone, tablet PC, or the like owned by a user, and may include all types of terminals capable of connecting to a wired/wireless network.

The computing device 100 may achieve desired system performance using a combination of typical computer hardware (e.g., devices including computer processors, memory, storage, input devices, and output devices, and other components of conventional computing devices; electronic communication devices such as routers and switches; electronic information storage systems such as network-attached storage (NAS) and storage area networks (SAN)) and computer software (i.e., instructions that enable the computing device to function in a specific manner).

The control unit 110 may generally handle the overall operation of the computing device 100. The control unit 110 may process signals, data, information, etc., input or output through the components of the computing device 100 or drive applications stored in the storage unit 120 to provide or process appropriate information or functions for the user.

The control unit 110 may be composed of one or more cores and may include processors for data analysis, such as a Central Processing Unit (CPU), a General Purpose Graphics Processing Unit (GPGPU), or a Tensor Processing Unit (TPU).

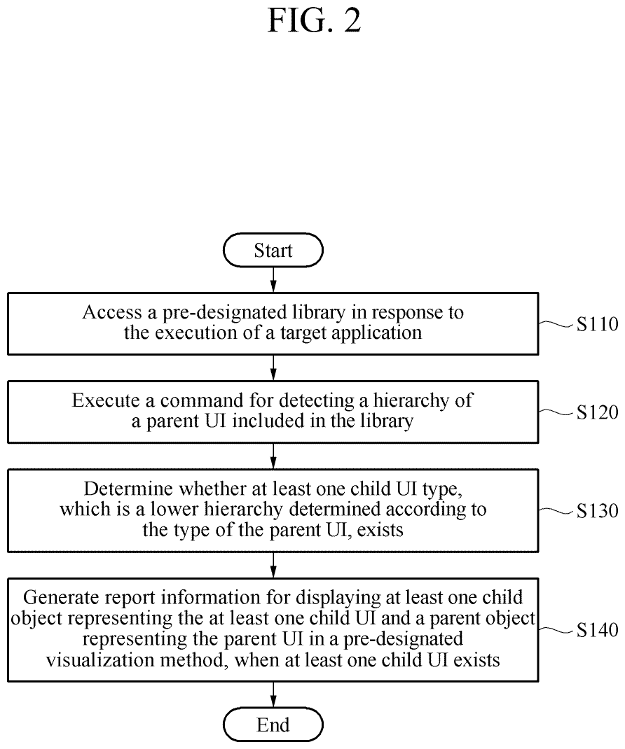

In the present disclosure, the control unit 110 may detect a hierarchy of a parent UI (User Interface). Here, the parent UI may be a user interface located at the topmost level hierarchically. For example, it can be assumed that an application such as “Integrated Patent Document Creator” exists. The parent UI may be assumed to be an activity class. In this case, the home screen or login screen of the “Integrated Patent Document Creator” application may be the parent UI. Alternatively, the parent UI may be assumed to be a DecorView class. In this case, the parent UI may be the topmost view of the activity or the like. The control unit 110 may determine whether a child UI type, which is a lower hierarchy determined according to the type of the parent UI, exists. For example, if the parent UI is an activity class, the control unit 110 may determine whether a child UI of the DecorView type exists. As another example, if the parent UI is a DecorView class, the control unit 110 may determine whether a child UI of the LinearLayout type exists. If a child UI exists, the control unit 110 may generate report information. The report information may be information for displaying the parent UI and the child UI in a pre-designated visualization method. The computing device 100 may transmit the report information to a server or the like, thereby causing the server to display a child object representing the child UI and a parent object representing the parent UI in the pre-designated visualization method. Hereinafter, an example of a method in which the control unit 110 generates report information will be described with reference to FIG. 2.

The storage unit 120 may comprise a memory and/or a permanent storage medium. The memory may comprise at least one type of storage medium, such as a flash memory type, a hard disk type, a multimedia card micro type, a card-type memory (e.g., SD or XD memory, etc.), Random Access Memory (RAM), Static Random Access Memory (SRAM), Read-Only Memory (ROM), Electrically Erasable Programmable Read-Only Memory (EEPROM), Programmable Read-Only Memory (PROM), magnetic memory, magnetic disk, or optical disk.

The communication unit 130 may comprise one or more modules enabling communication between the computing device 100 and a communication system, between the computing device 100 and a server, between the computing device 100 and another computing device, or between the computing device 100 and a network.

Hereinafter, a specific example of a method in which the computing device 100 supports information collection for screen components will be described.

FIG. 2 is a flowchart illustrating an example of a method in which a computing device supports information collection for screen components according to some embodiments of the present disclosure.

Referring to FIG. 2, the control unit 110 of the computing device 100 may access a pre-designated library in response to the execution of a target application (S110). Here, the target application may be an application pre-installed on the computing device 100. The target application may be an application in which an SDK (Software Development Kit) is installed in the form of a library. The library may be a program compiled to perform only specific partial functions and exist in the form of machine code. The execution of the target application may be performed according to user interaction.

|The control unit 110 may execute a command for detecting a hierarchy of a parent UI (User Interface) included in the library (S120). The parent UI may be a user interface located at the topmost position hierarchically. The command may be a script or the like. The script may be a programming language that can be executed without compiling the source code. The control unit 110 may detect the hierarchy of the parent UI according to the execution of the command.

According to one embodiment, the command may comprise a first command and a second command.

The first command may be a command defining a type of at least one child UI to be detected according to the type of the parent UI.

For example, it may be assumed that an application such as “Integrated Patent Document Editor” exists. The parent UI may be assumed to be an activity class. In this case, the home screen or login screen of the “Integrated Patent Document Editor” application may be a parent UI that is an activity class. When the type of the parent UI is an activity class, a child UI may include a DecorView class. The first command may be a command defining that the type of at least one child UI is a DecorView according to the type of the parent UI, which is an activity class.

The second command may be a command for detecting at least one child UI.

For example, the type of at least one child UI may have been defined as a DecorView by the first command. In this case, the second command may be a command for detecting at least one child UI of the DecorView type.

The control unit 110 may determine whether at least one child UI type, which is a lower hierarchy determined according to the type of the parent UI, exists (S130).

For example, the control unit 110 may determine that at least one child UI exists in the lower hierarchy of the parent UI when at least one child UI of the DecorView type is detected by the second command.

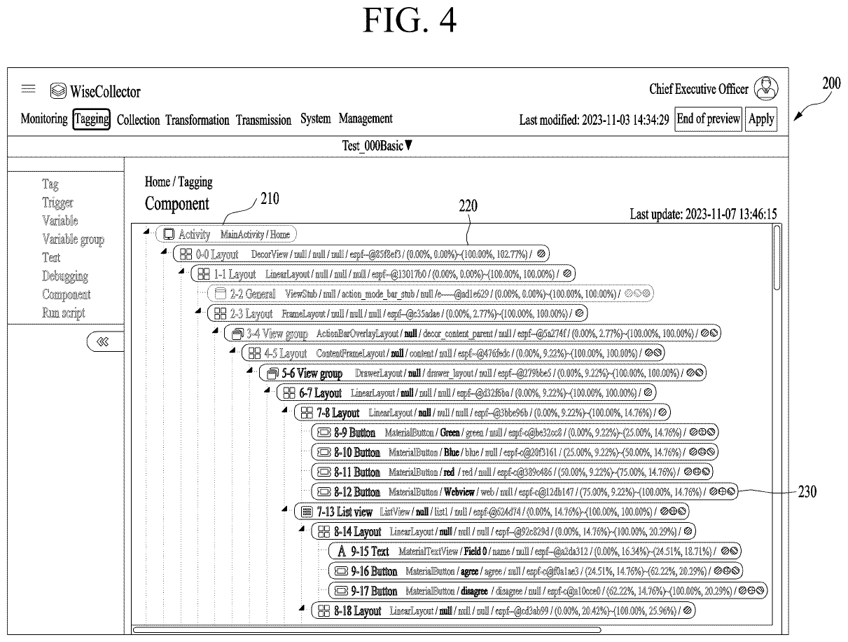

When at least one child UI exists, the control unit 110 may generate report information for displaying at least one child object representing the at least one child UI and a parent object representing the parent UI in a pre-designated visualization method (S140). Then, the control unit 110 may transmit the generated report information to a server or another computing device through the communication unit 130. Here, the pre-designated visualization method may be, for example, a tree structure. For convenience of explanation, FIG. 4 may be referred to.

FIG. 4 is a diagram illustrating an example of screen components according to some embodiments of the present disclosure. FIG. 4 may be a screen 200 displayed on a server that has received report information from the computing device 100.

Referring to FIG. 4, the screen 200 may display a parent object 210 and a child object 220 in a pre-designated visualization method as report information is received from the computing device 100. For example, the screen 200 may display the parent object 210 and the child object 220 in a tree structure.

According to the above configuration, the computing device 100 may execute a command for detecting a hierarchy of a parent UI included in a pre-designated library in response to the execution of a target application. The command for detecting the hierarchy of the parent UI may be a script or the like that does not require rebuilding or redistributing the target application. In other words, the command may be a programming language that can be executed without compiling the source code. The computing device 100 may generate report information such that a parent object representing the parent UI and at least one child object representing at least one child UI are displayed on a server in a pre-designated visualization method according to the execution of the command. Then, the computing device 100 may transmit the generated report information to the server. Accordingly, a user may conveniently collect information about screen components.

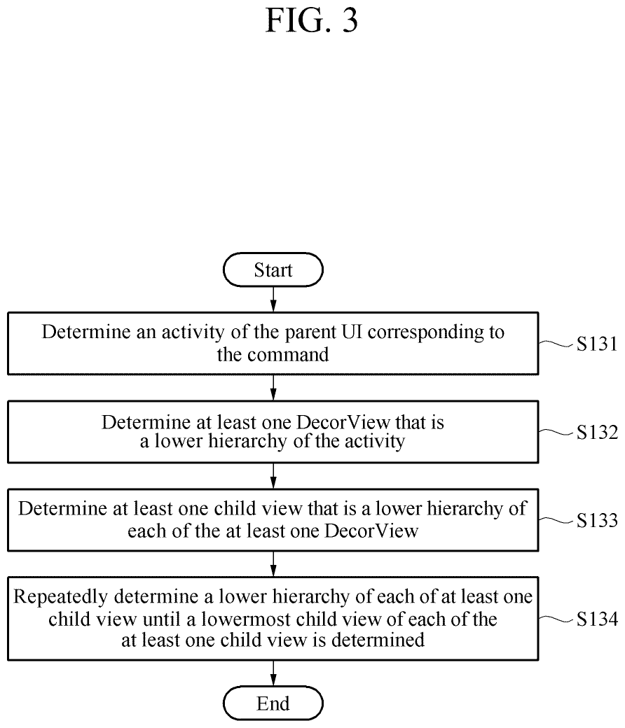

Meanwhile, according to some embodiments of the present disclosure, when the computing device 100 determines whether at least one child UI type exists, the computing device 100 may repeatedly determine whether at least one child UI type exists until a lowermost child UI located at a hierarchically lowermost position is determined. Hereinafter, an example of a method in which the computing device 100 determines a lowermost child UI located at a hierarchically lowermost position according to the present disclosure will be described with reference to FIG. 3.

FIG. 3 is a flowchart illustrating an example of a method in which a computing device determines a lowermost child UI located at a hierarchically lowermost position according to some embodiments of the present disclosure.

Referring to FIG. 3, the control unit 110 of the computing device 100 may determine an activity of the parent UI corresponding to the command (S131).

Specifically, the control unit 110 may determine an activity of the parent UI corresponding to the command according to the execution of the command for detecting the hierarchy of the parent UI.

The control unit 110 may determine at least one DecorView that is a lower hierarchy of the activity (S132). At least one DecorView may be a child UI type determined according to the parent UI being of the activity type.

The control unit 110 may determine at least one child view that is a lower hierarchy of each of the at least one DecorView (S133). At least one child view may be, for example, a LinearLayout.

According to one embodiment, the command may comprise a third command defining a type of at least one second child UI to be detected according to the type of a first child UI and a fourth command for detecting at least one second child UI.

For example, when the type of the first child UI is a DecorView class, a child UI may include a LinearLayout. The third command may be a command defining that the type of at least one second child UI is a LinearLayout according to the type of the first child UI, which is a DecorView class. Then, the fourth command may be a command for detecting at least one second child UI of the LinearLayout type.

The control unit 110 may repeatedly determine a lower hierarchy of each of at least one child view until a lowermost child view of each of the at least one child view is determined (S134). The lowermost child view may be a lowermost child UI located hierarchically at the lowest position.

For example, the control unit 110 may detect the lowermost child UI by repeatedly determining whether at least one child UI type, such as ViewStub, FrameLayout, or ActionBarOverlayLayout, exists according to the execution of a command.

Meanwhile, when the lowermost child UI is detected, the control unit 110 may generate report information for displaying at least one child object representing at least one child UI including the lowermost child UI and a parent object representing the parent UI in a pre-designated visualization method. Further, the control unit 110 may transmit the generated report information to a server or another computing device through the communication unit 130. Accordingly, the screen components may be displayed in the pre-designated visualization method on the server or another computing device.

FIG. 4 is a diagram for explaining an example of screen components according to some embodiments of the present disclosure. FIG. 4 may be a screen 200 displayed on a server that has received report information from the computing device 100.

Referring to FIG. 4, on the screen 200, as the report information is received from the computing device 100, a parent object 210 representing the parent UI, a child object 220 representing the child UI, and a lowermost child object 230 representing the lowermost child UI may be displayed in a pre-designated visualization method.

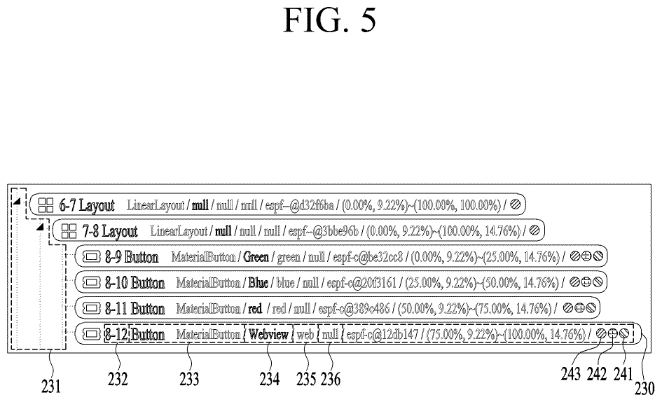

Meanwhile, according to some embodiments of the present disclosure, at least one child object may include at least one of depth information, an index, a class, text, an ID (Identifier), and a tag. Hereinafter, at least one child object according to the present disclosure will be described with reference to FIG. 5.

FIG. 5 is a diagram for explaining at least one child object according to some embodiments of the present disclosure. In FIG. 5, an example of at least one child object is explained through the lowermost child object 230.

Referring to FIG. 5, the lowermost child object 230 representing the lowermost child UI may include at least one of depth information 231, an index 232, a class 233, text 234, an ID 235, and a tag 236.

The depth information 231 may indicate a depth in the visualization method. The depth information 231 may represent the depth between at least one child object and the parent object. The depth information 231 may indicate the extent to which related data must be searched from the application to reach the corresponding data.

The index 232 may be an index for quickly finding objects among a large amount of data. For example, a user may quickly find the lowermost child object 230 through the index 232, such as 8-12.

The class 233 may represent a type of at least one child UI. The class 233 may indicate types of UI such as buttons, text, images, etc.

The text 234 may be text displayed on the front-end by at least one child UI. In other words, the text 234 may represent text directly confirmed by the user at the user end of the application.

The ID 235 may represent an ID of at least one child UI. The ID 235 may be an internal name of at least one child object or a unique name designated by a client developer.

The tag 236 may represent a tag assigned to at least one child UI. The tag 236 may indicate additional information or related data when a client developer sets tag information for the corresponding UI.

Meanwhile, according to some embodiments of the present disclosure, at least one child object may include at least one indicator. The indicator may be a graphic object for providing information to the user.

For example, at least one child object may include a first indicator 241, a second indicator 242, a third indicator 243, and a fourth indicator (not shown).

The first indicator 241 may indicate whether an ID is assigned to at least one child UI. According to one embodiment, the first indicator 241 may indicate whether an ID is assigned to at least one child UI by being assigned a color. The first indicator 241 may be assigned a blue color.

The second indicator 242 may indicate whether at least one child UI has an operation according to user interaction. According to one embodiment, the second indicator 242 may indicate whether at least one child UI has an operation according to user interaction by being assigned a color. The second indicator 242 may be assigned a yellow color.

The third indicator 243 may indicate whether a trigger is assigned to at least one child UI. According to one embodiment, the third indicator 243 may indicate whether a trigger is assigned to at least one child UI by being assigned a color. The third indicator 243 may be assigned a green color.

The fourth indicator may indicate whether at least one child UI is a UI displayed to a user. According to one embodiment, the fourth indicator 244 may indicate whether at least one child UI is a UI displayed to a user by being assigned a color. The fourth indicator 244 may be assigned a black color.

The control unit 110 may generate a command for supporting the generation of a plurality of graphic objects representing at least one indicator, such as the first indicator 241 to the fourth indicator, as report information. Further, the control unit 110 may transmit the generated report information to a server or another computing device through the communication unit 130. Accordingly, a plurality of graphic objects, such as the first indicator 241 to the fourth indicator, may be displayed on the server or another computing device.

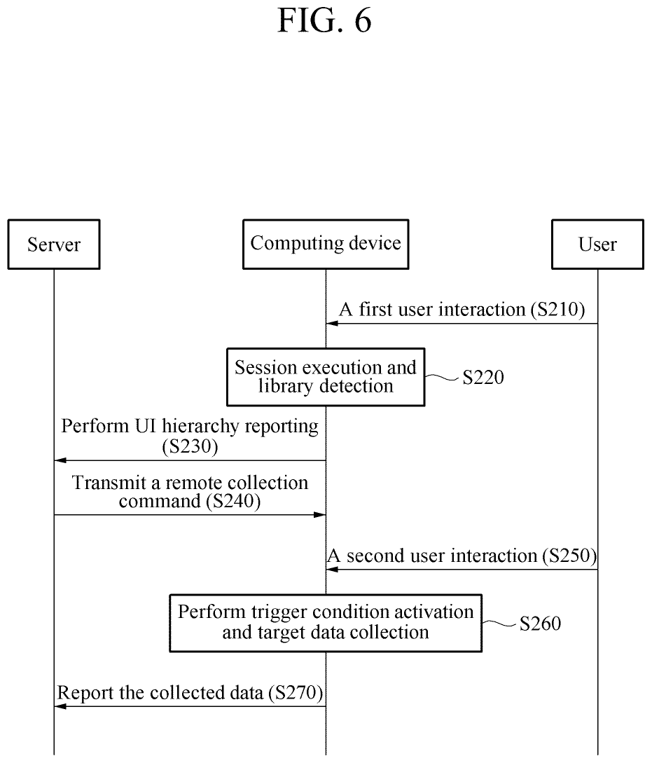

FIG. 6 is a flowchart for explaining an example of a method for collecting screen components performed between a user, a computing device, and a server according to some embodiments of the present disclosure.

Referring to FIG. 6, the computing device 100 may perform session execution and library detection according to a first user interaction (S210, S220). The first user interaction (S210) may be an interaction for executing a target application. A session may be a logical connection period for communication between the user, the computing device 100, and the server. The computing device 100 may access a pre-designated library in response to the execution of the target application. The computing device 100 may execute a command for detecting a hierarchy of a parent UI included in the library. The computing device 100 may determine whether at least one child UI type, which is a lower hierarchy determined according to the type of the parent UI, exists. The computing device 100 may generate report information for displaying at least one child object representing at least one child UI and a parent object representing the parent UI in a pre-designated visualization method when at least one child UI exists.

The computing device 100 may perform UI hierarchy reporting (S230). In other words, the computing device 100 may transmit the generated report information to the server.

Meanwhile, the computing device 100 may receive a remote collection command from the server (S240). The remote collection command may be a command for collecting data related to the computing device 100. The remote collection command may include items such as a tag item, a trigger item, and a variable item.

The computing device 100 may perform trigger condition activation and target data collection according to a second user interaction (S250, S260).

The second user interaction may be an interaction that is the subject of the trigger condition. For example, the trigger condition may be an interaction such as a button click, a button touch, a specific key click, a specific key touch, a specific item click, or a specific item touch. The target data may be data designated as a tag item.

The computing device 100 may report the collected data to the server (S270).

The description of the presented embodiments is provided to enable any person skilled in the art to which this disclosure pertains to utilize or implement this disclosure. Various modifications to these embodiments will be apparent to those skilled in the art, and the general principles defined herein may be applied to other embodiments without departing from the scope of this disclosure. Accordingly, this disclosure is not to be limited to the embodiments set forth herein but is to be construed in the broadest scope consistent with the principles and novel features disclosed herein.

What is claimed is:

1. A method for supporting information collection for screen components performed by a computing device including at least one processor, comprising:
accessing a pre-designated library in response to execution of a target application;
executing a command for detecting a hierarchy of a parent User Interface (UI) included in the library;
determining whether at least one child UI type, which is a lower hierarchy determined according to a type of the parent UI, exists; and
when the at least one child UI exists, generating report information for displaying at least one child object representing the at least one child UI and a parent object representing the parent UI in a pre-designated visualization method.

2. The method according to claim 1, wherein
the command includes a first command defining a type of at least one child UI to be detected according to the type of the parent UI and a second command for detecting the type of the at least one child UI.

3. The method according to claim 1, wherein
the determining whether at least one child UI type, which is a lower hierarchy determined according to the type of the parent UI, exists comprises:
repeatedly determining whether the at least one child UI type exists until a lowermost child UI located at a hierarchically lowermost position is determined.

4. The method according to claim 3, wherein
the repeatedly determining whether the at least one child UI type exists until the lowermost child UI located at the hierarchically lowermost position is determined comprises:
determining an activity of the parent UI corresponding to the command;
determining at least one DecorView that is a lower hierarchy of the activity;
determining at least one child view that is a lower hierarchy of each of the at least one DecorView; and
repeatedly determining a lower hierarchy of each of the at least one child view until a lowermost child view of each of the at least one child view is determined.

5. The method according to claim 1, wherein
the at least one child object includes at least one of depth information indicating a depth in the visualization method, an index of the at least one child UI, a class indicating a type of the at least one child UI, a text displayed on a front-end by the at least one child UI, an ID of the at least one child UI, and a tag assigned to the at least one child UI.

6. The method according to claim 1, wherein
the generating the report information for displaying comprises
generating a command for supporting generation of a plurality of graphic objects indicating at least one of a first indicator indicating whether an ID is assigned to the at least one child UI, a second indicator indicating whether the at least one child UI has an operation according to user interaction, a third indicator indicating whether a trigger is assigned to the at least one child UI, and a fourth indicator indicating whether the at least one child UI is a UI displayed to a user, as the report information.
